(19) United States
(12) Patent Application Publication
(10) Pub. No.: US 2013/0091749 A1
(43) Pub. Date: Apr. 18, 2013

(54) METHOD OF ADVERTISING HOUSEHOLD ITEMS

(71) Applicant: Louis L. Glickfield, Rockville, MD (US)

(72) Inventor: Louis L. Glickfield, Rockville, MD (US)

(21) Appl. No.: 13/276,296

(22) Filed: Oct. 18, 2011

(51) Int. Cl. G09F 15/00; G09F 7/00

(52) U.S. Cl. 40/606.01; 40/584

(57) ABSTRACT

A method for advertising household items by placing a graphic display of the household item in the vicinity of the household item at a retail location. The household item in the household display is shown in the environment in which it is intended to be utilized. The ability to view the household item in the particular environment for which it is design enhances the consumer experience and facilitates a confident decision by the purchasers. The method of advertising household items also entails preparing the graphic display, printing the graphic display, framing the graphic display, and placing the graphic display in the vicinity of the household item.

### BACKGROUND OF THE INVENTION

1. Field of the Invention

This invention relates to a method for advertising household items at retail locations.

2. Description of the Background

Household items are currently advertised in catalogues, printed magazines, and other media in which a consumer can view the item in various settings. Catalogues may be found at retail locations near the checkout counter and in some instances near the household item. Newspaper and magazine ads may allow a consumer to visualize the item in a particular setting. Billboards are placed outside buildings and on the street to advertise stores and other services to the public. However, none of the known methods allow the consumer to see a large rendition of the item in the specific setting in which it will be used near the household item the individual is about to purchase.

### SUMMARY OF THE INVENTION

A method for advertising household items is described in which a graphic display showing the household item, as it would look in a particular room setting or natural environment, is placed in the vicinity of a household item. In an alternative embodiment, a method of advertising a household item is provided. In the first step of the method consists of preparing a graphic display image of a household item in its environment. The second step consists of printing the graphic display. The third step consists of framing the graphic display. And, the final step consists of placing the graphic display in the vicinity of the household item.

### BRIEF DESCRIPTION OF THE DRAWINGS

The above and other features, aspects, and advantages of the present invention are considered in more detail, in relation to the following description of embodiments thereof shown in the accompanying drawings, in which:

FIG. 1 is a flow diagram of a method in accordance with one aspect of the present invention.

FIG. 2 is a graphic display of the method in accordance with one embodiment of the present invention.

FIG. 3 is a flow diagram of a method in accordance with the one embodiment of the present invention.

FIG. 4 is a flow diagram of a method of accessorizing a room in accordance with a further embodiment of the present invention by displaying the household item in a computer screen.

FIG. 5 is a flow diagram of a method of accessorizing a room in accordance with a further embodiment of the present invention by displaying the household item in a computer screen.

FIG. 6A is a picture of the graphic display in accordance with one embodiment of the present invention showing a sofa in a room setting, where the graphic display is placed next to the sofa on the sales floor.

FIG. 6B is a close up picture of the graphic display shown in FIG. 6A in accordance with one embodiment of the present invention showing a sofa in a room setting, where the graphic display is placed next to the sofa on the sales floor.

FIG. 7A is a picture of the graphic display in accordance with one embodiment of the present invention showing a sofa in a room setting, where the graphic display is placed next to the sofa on the sales floor.

FIG. 7B is a close up picture of the graphic display shown in FIG. 6A in accordance with one embodiment of the present invention showing a sofa in a room setting, where the graphic display is placed next to the sofa on the sales floor.

FIG. 8A is a picture of the graphic display in accordance with one embodiment of the present invention showing a dining room set in a room setting, where the graphic display is placed on the dining room set on the sales floor.

FIG. 8B is a close up picture of the graphic display shown in FIG. 6A in accordance with one embodiment of the present invention showing a dining room set in a room setting, where the graphic display is placed on the dining room set on the sales floor.

### DETAILED DESCRIPTION

The invention summarized above may be better understood by referring to the following description, the accompanying drawings, and the claims listed below. This description of an embodiment, set out below to enable one to practice an implementation of the invention, is not intended to limit the preferred embodiment, but to serve as a particular example thereof. Those skilled in the art should appreciate that they may readily use the conception and specific embodiments disclosed as a basis for modifying or designing other methods and systems for carrying out the same purposes of the present invention. Those skilled in the art should also realize that such equivalent assemblies do not depart from the spirit and scope of the invention in its broadest form.

It is an object of one embodiment of the present invention to provide a method for advertising at a retail location, such as a furniture store, a carpeting store, flooring store, light fixture retail establishment, appliances store, and any other type of retail store that sells household items to consumers. The method allows a consumer to have confidence in the purchasing decision. The heightened confidence in the purchase helps the consumer make the most appropriate decision for his or her situation. Such confidence increases the likelihood that the consumer will finalize the sale. Furthermore, providing the consumer with the right item for his or her household reduces the number of returns of merchandise. The ability to make an informed decision about the purchase enhances the customer's experience at the store and, thus, it is likely that the customer will return for future purchases.

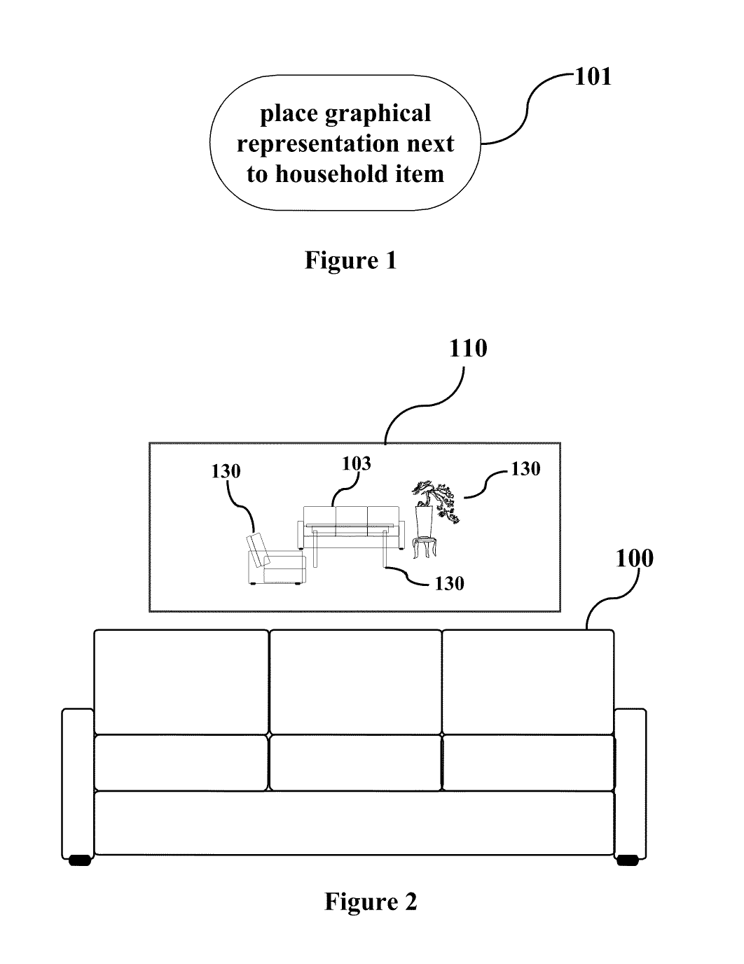

In one aspect of the present invention, a method of advertising household items is provided. The household item may be a chair, table, sofa, dining room set, and any other type of furniture. The household item may also include flooring, whether wood flooring or carpeting. The household item may further include appliances, such as refrigerators, washer machines, dryer machines, televisions and any other type of appliance. The household item may further include lighting fixtures, kitchen fixtures, bathroom fixtures, and other such items placed in the home. As shown in FIG. 1, the method consists of one step 101 of placing a graphic display 110 of a household item 100 next to the household item 100 at a retail location. The graphic display 110 shows a graphical representation 103 the household item 100 in an environment. The environment is a setting similar to that in which a purchaser will place the household item 100 after the purchase. The graphic display is printed in any size, for example, the graphic display may be a 30 in by 40 in living room display; it may be a 30 in by 60 in sectional display; the graphic display may also be a 24 in by 36 in bedroom or dining room display. It is contemplated that the graphic display may be of any size that is larger than a picture in a catalogue.

As shown in FIG. 2, a graphic display 110 of a household item 100 is placed near the household item 100. The graphic display 110 shows a graphical representation 103 of the household item 100 as it would look in its environment at a home. By way of example, as shown in FIG. 2, the household item 100 may be a piece of furniture, an appliance, or another household item that is going to be placed in a particular place and for which the aesthetic properties of the product are important to the consumer. As shown in FIG. 2, a graphic display 120 of a sofa, as it would look in a given room, is placed behind the sofa. The graphic display 110 of the sofa includes a room in which the sofa is placed and other accessories 130. The accessories 130 may include a table, a plant, paintings, other furniture next to the sofa, and any other items that are appropriate for the type of household item being sold. The graphic display 110 allows the consumer to visualize how the household item 100 will look in a particular setting, such as a dining room, living room, or other desired setting.

The graphic display 110 includes a graphical representation 103, a picture or a drawing, of the household item 100 in the environment in which the household item 100 is going to be utilized. In some embodiments of the present invention, the graphic display 100 is a picture that can be taken with an analog camera, a digital camera, or any other device that allows a person to capture an image of the household item 100 in its natural or designated environment. In an alternative embodiment the graphic display 100 is a drawing. Some drawings of the graphic display 100 are drafted by hand on a medium to be placed near the household item 100. Other drawings are generated electronically through computer software that allows a designer to create a graphic display 100 that is later printed and placed in the vicinity of the household item 100. In some instances, analog pictures, those taken with a film camera, are converted to digital files that are later printed onto various media that serve as the graphic display 110.

The graphic display 110 of the household item in its intended setting is printed onto a medium for display in the vicinity of the household item 100. The medium is selected from many different types of media. Such media include plain paper, photo paper, glossy paper, canvas, and any other type of media that provides a desirable image in the graphic display 110. The graphic display 110 is printed, or rendered, in various sizes depending on the intended location of the display, the size of the household item 100, and the space available on the showroom floor.

The graphic display 110 is printed onto the media using various methods known to a person of ordinary skill in the art. In one preferred embodiment of the present invention, the graphic display 110 is printed onto the media (paper, canvas, or any other media as described above) utilizing the well-known Giclée method. This method results in a high resolution graphical display 110 for use in the method described above. Once the image is printed onto the media, the graphic display 110 is prepared for placement in the vicinity of the household item 100. In one example, the graphic display 110 is prepared as an “artist wrap.” An “artist wrap” is a method of preparing the graphic display 110 by mounting it on a wooden frame and wrapping the edges of the graphic display 110 around the frame. In another example, the graphic display 110 is placed on a picture frame having a border. In a further example, a transparent material is placed in front of the graphic display 110, the transparent material may be glass or plastic or any other material that allows a person to see the graphic display 110. In yet a further example, the graphic display 110 is placed on a poster board or other type of board that allows the graphic display 110 to be mounted on a tripod or other display apparatus or device.

It is expected that any type of framing material can be used in association with the graphic display 110. The framing material can be plastic, metal, wood, or any other type of material that provides a rigid frame for the display. When utilizing wood, any type of wood may be used as recognized by a person of ordinary skill in the art. In one preferred embodiment, thermal pressed wood is utilized for framing the graphic display 110. In a further preferred embodiment, the type of wood utilized meets the standards required for export or import of wood into various countries.

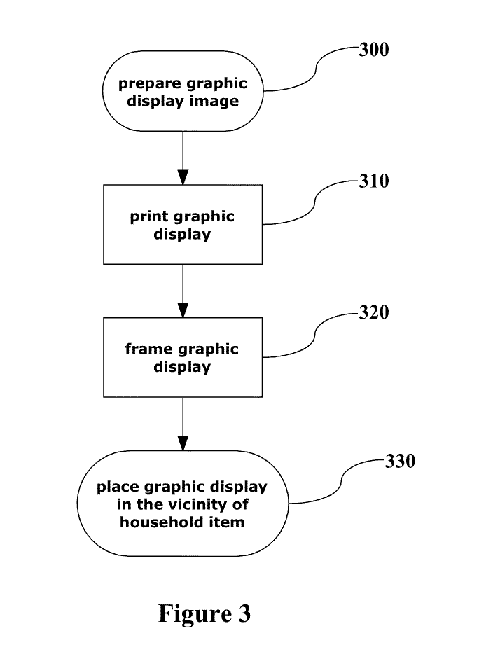

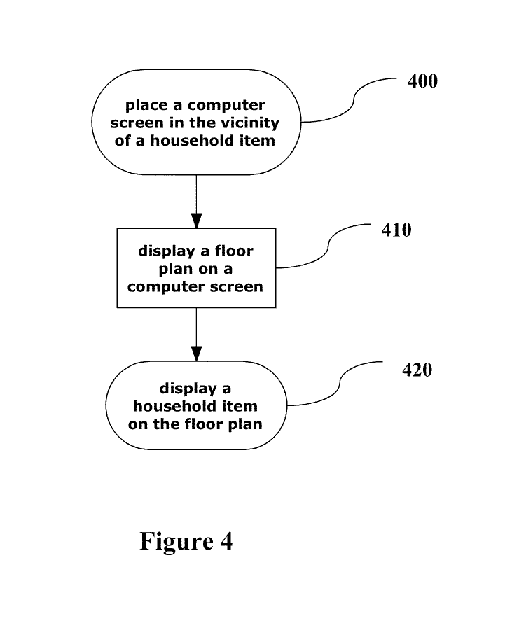

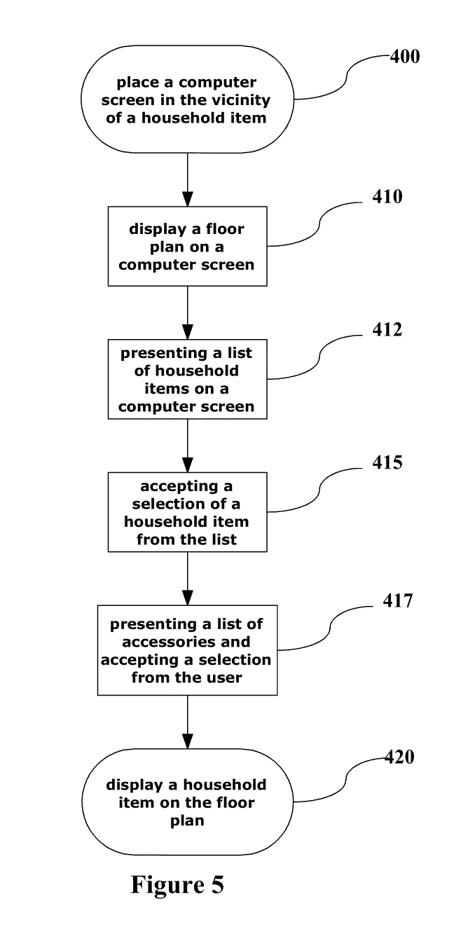

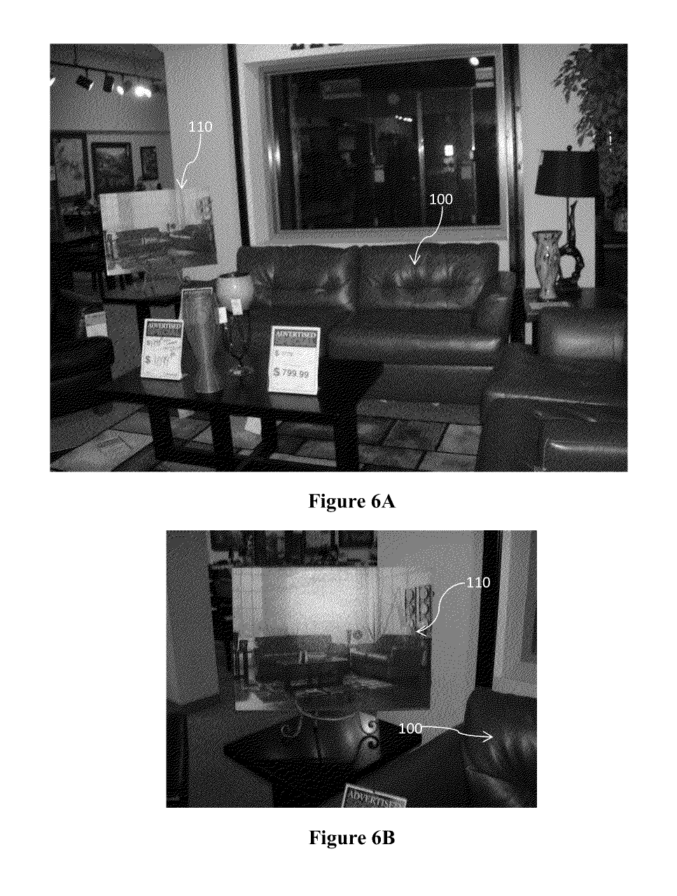

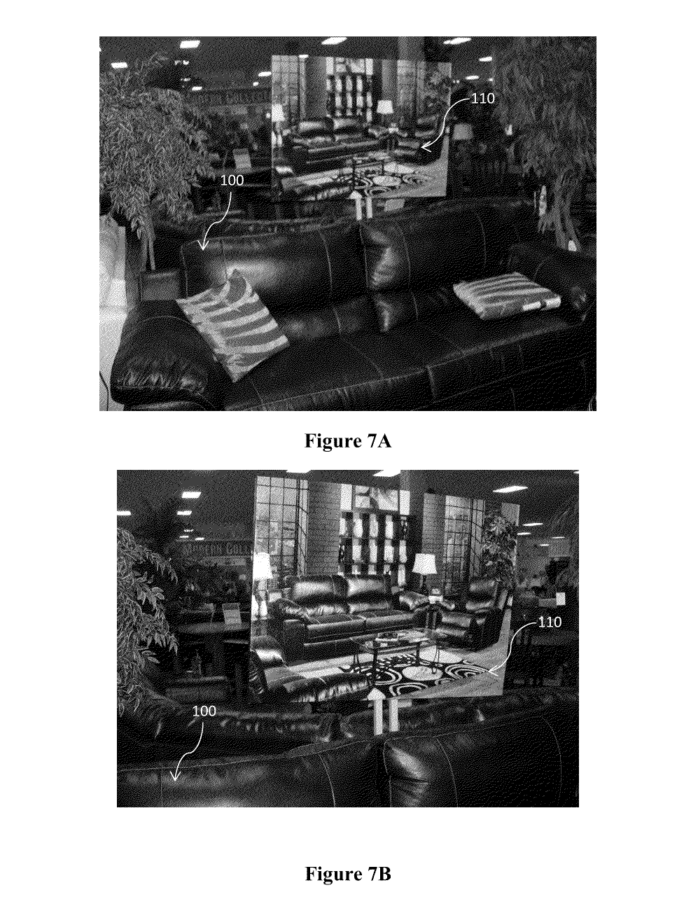

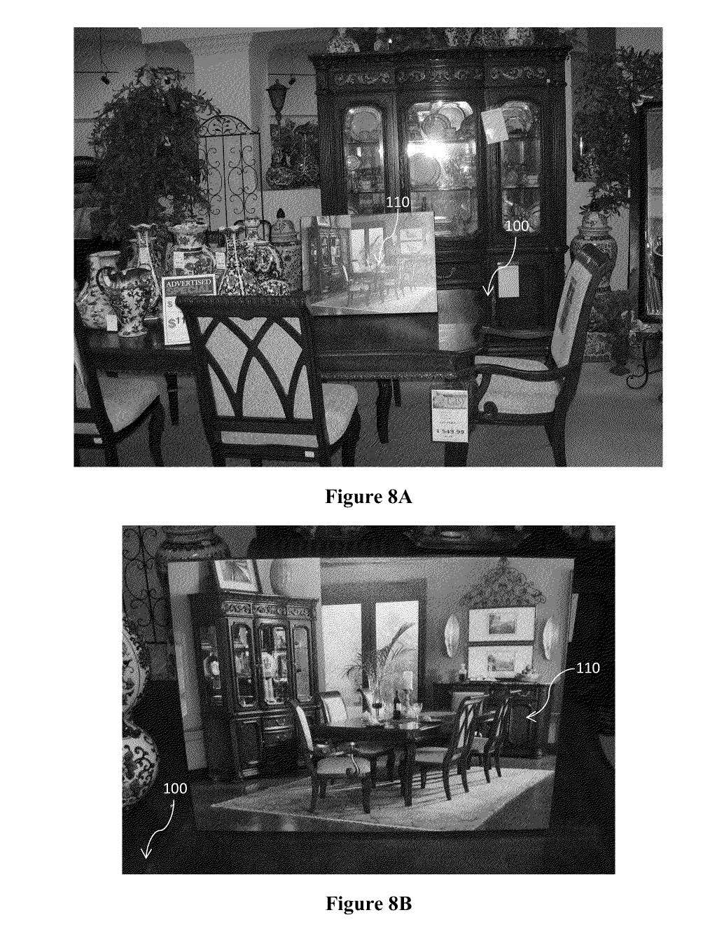

A preferred embodiment of the present invention presents a method for advertising household items 100 as shown in FIG. 3. In the first step of the method 300 a graphic display 110 image is prepared. The graphic display 110 shows the household item 100 as it would look in its environment at a home or other setting as described above. In a second step 310 of the method, the graphic display 110 is printed onto media. The graphic display 110 is printed utilizing the Giclée method in one preferred embodiment of the method. In other embodiments, the graphic display 110 is printed utilizing other methods known to a person of ordinary skill in the art.

In a third step 320 of the method, the graphic display 110 is framed. In one preferred embodiment the graphic display 110 is framed as an artist wrap as described above. In a second preferred embodiment, the graphic display 110 is framed in a picture frame with borders. In yet a further embodiment of the invention, the graphic display 110 is placed on poster board. In a final step 330 of the method, the graphic display 110 is placed in the vicinity of the household item 100 to which it pertains. Placing the graphic display 110 in the vicinity of the household item 100 enhances a consumer's experience and confidence in making the buying decision.

In a further embodiment of the present invention, the retail store has the floor plans of apartment or housing complexes in the area of the retail store. The floor plans are used to create graphic displays 110 in accordance with the present invention showing the household items as they would look in the particular floor plan for that apartment or housing complex. The graphic displays 110 of such floor plans are available for the customer at the retail store and allow him or her to see exactly how the household item 100 will look in the room where it will be placed.

The method of the present invention may also be used in other settings. For example, furniture stores may utilize the method in association to apartment complexes and housing complexes where multiple units have similar floor plans. The furniture store may prepare graphic displays 110 of the store's household items on the showroom using the floor plans of the apartments or houses in the apartment or housing complex. In this preferred embodiment of the invention, the graphic display 100 may not necessarily be printed and displayed in the vicinity of the household item, the graphic display 100 shows the layout of the room in a computer screen.

In a first step 400, a computer screen is placed in the vicinity of a household item 100. It is contemplated that the computer screen may be a regular computer screen or any other type of screen that allows the display of the household item 100 in the environment in which it is expected to be used. In a later step 410, the floor plan of a room in which the household item is to be used is displayed on the computer screen. In a final step 420, the household item is displayed in the floor display on the computer screen.

In one preferred embodiment of the present invention, access to a database of floor plans is provided through the computer screen. The database may be stored in the computer or accessible through a network, such as the internet. A user is given the opportunity to select a floor plan from the list of floor plans available in the database. A database of household items 100 and accessories 130 may also be accessed through the computer screen. In a further preferred embodiment, a database of various layouts for household items 100 is accessible to the computer screen. A person of ordinary skill in the art would understand that access to the databases described above may be accomplished in many different ways and displayed on the computer screen. The computer screen may be connected to a processor, a server, the internet, a keyboard, and other devices that allow it to access and utilize the databases described above.

In one step 412, a user is presented with a graphical representation of the household item or the layout of a particular room in one of the floor plans provided on the computer screen and selected from the database described above. In a further step 415, the user is provided the opportunity to select a household item or layout for display. In a further step 420, the household item is displayed in the floor plan on the computer screen. In one embodiment of the present invention, a step 417 allows the user to select the accessories 130 to be displayed with the household item 100. In accordance with this method, a user can accessorize his or her apartment or house with confidence that the furniture and accessories are appropriate for each room. In particular, the method allows the consumer to ensure that the household item, such as furniture, will fit in the room selected by the user.

The invention has been described with references to a preferred embodiment. While specific values, relationships, materials and steps have been set forth for purposes of describing concepts of the invention, it will be appreciated by persons skilled in the art that numerous variations and/or modifications may be made to the invention as shown in the specific embodiments without departing from the spirit or scope of the basic concepts and operating principles of the invention as broadly described. It should be recognized that, in the light of the above teachings, those skilled in the art can modify those specifics without departing from the invention taught herein. Having now fully set forth the preferred embodiments and certain modifications of the concept underlying the present invention, various other embodiments as well as certain variations and modifications of the embodiments herein shown and described will obviously occur to those skilled in the art upon becoming familiar with such underlying concept. It is intended to include all such modifications, alternatives and other embodiments insofar as they come within the scope of the appended claims or equivalents thereof. It should be understood, therefore, that the invention may be practiced otherwise than as specifically set forth herein. Consequently, the present embodiments are to be considered in all respects as illustrative and not restrictive.

1. A method for advertising a full size furniture item and enhancing consumer confidence when considering the furniture item purchase, comprising:
placing a graphic display of the furniture item next to the furniture item, and on a separate structure, at a retail location, wherein the graphic display shows the furniture item in a setting similar to that in which a purchaser will place the furniture item.

2. The method of claim 1, wherein the graphic display is printed on a medium selected from the group consisting of plain paper, glossy paper, poster board, and canvas.

3. The method of claim 1, wherein the graphic display is printed utilizing the Giclée method.

4. The method of claim 1, wherein the graphic display is mounted on a frame.

5. The method of claim 4, wherein the frame is selected from the group consisting of a wooden frame, a plastic frame, and a metal frame.

6. The method of claim 4, wherein the graphic display is mounted on the frame as an artist wrap.

7. A method for advertising a full size furniture item, comprising:
preparing a graphic display image of a furniture item in an environment;
printing the graphic display,
framing the graphic display,
placing the graphic display next to the furniture item, on a separate structure.

8. The method of claim 7, wherein the graphic display is a photograph or a drawing of the household item in an environment.

9. The method of claim 7, wherein the graphic display is created on a computer.

10. The method of claim 7, wherein the printing step is accomplished utilizing the Giclée method.

11. The method of claim 7, wherein the graphic display is mounted on a wooden frame, a plastic frame, or a metal frame.

12. The method of claim 10, wherein a border is placed on the graphic display.
